(19) United States
(12) Patent Application Publication
(10) Pub. No.: US 2020/0191174 A1
(43) Pub. Date: Jun. 18, 2020

(54) MULTI-CHANNEL HYDRAULIC SNUBBING DEVICE

(71) Applicant: Safran Landing Systems Canada Inc., Ajax (CA)

(72) Inventors: Ryan Tam, Ajax (CA); Joseph Lan, Ajax (CA)

(73) Assignee: Safran Landing Systems Canada Inc., Ajax (CA)

(21) Appl. No.: 16/219,419

(22) Filed: Dec. 13, 2018

(51) Int. Cl. F15B 15/22; F15B 11/12; F15B 15/14; B64C 25/60; B22F 3/105

(52) U.S. Cl. CPC F15B 15/222; F15B 11/123; F15B 15/1457; B33Y 10/00; B64C 25/60; B22F 3/1055; B22F 2003/1057; F15B 15/1438

(57) ABSTRACT

Examples that relate to snubbing devices to arrest or resist motion are provided. These snubbing devices are suitable for use with actuators, such as linear actuators, that desire load damping or piston speed change at the end of stroke movement of the actuator. Embodiments of the present disclosure also relate to linear actuators having a snubbing device for dampening loads, reducing piston velocity, etc., at the end of stroke movement of the actuator. In some embodiments, the snubbing device and/or other components of the actuator can benefit from additive manufacturing techniques or methodologies.

### BACKGROUND

Linear actuators are commonly used to propel or oscillate mechanical components. Some of these linear actuators will use a snubbing arrangement to arrest the movement of the actuator member at the end of its stoke. One snubbing arrangement, shown in FIGS. 1A and 1B, includes a piston entering into a cavity having a main discharge orifice at a predetermined distance from the end of the stroke and a smaller, secondary orifice positioned between the main discharge orifice and the closed end. In use, the piston moves towards the dosed end from a first position (FIG. 1A) to a second position (FIG. 1B). As shown in FIGS. 1A-1B, there is unrestricted flow until the piston crosses or passes the main orifice at which point the only fluid path is through the smaller, secondary orifice shown next the closed end. This smaller, secondary orifice acts to restrict the fluid discharged from the unpressurized chamber until the end of the stroke is reached.

Some snubbing schemes depend on the resistance to fluid flow through passages, as set forth briefly above. This can be problematic in some applications because the resistance in the fluid is sensitive to many factors. To ensure that the snubbing action is consistent, the rod and cylinder assemblies that comprise the actuator must be carefully aligned by controlling the manufacturing tolerances on mating features to a very high degree of precision, which drives up cost. Nevertheless, the amount of resistance to the fluid flow is highly dependent on the area of the annulus formed by the piston, the shape of the annulus (it may be irregular due to positional misalignment), and the change in fluid viscosity due to temperature changes.

Snubbing schemes for actuators used in aerospace applications commonly require holes to be drilled in the cylinder of the actuator in areas of high stress concentration creating a fatigue issue especially in applications requiring high pressure (5000 psi, for example). In the example snubbing arrangement of FIGS. 1A-1B, drilling a hole close to the junction of the cylinder body and closed end or head can lead to failures in high pressure applications. Other designs can require an overlap of the lug end over the outer cylinder that would require fluid to pass through two separate components that require complex and costly sealing arrangements.

### SUMMARY

In accordance with an aspect of the present disclosure, a snubbing device is provided. The snubbing device comprises a piston housing having an interior, at least one closed end, and a discharge port disposed close to the closed end, a piston disposed in the interior of the piston housing and forming a fluid chamber between one end of the piston and the closed end of the piston housing, and a 3-D printed restrictor positioned against the closed end of the piston housing. The restrictor is some embodiments has a plurality of passageways connected in fluid communication with the discharge port.

In some embodiments, the 3-D printed restrictor includes a snubbing ring that is inserted into the interior of the piston housing and positioned adjacent the closed end.

In some embodiments, the 3-D printed restrictor includes a snubbing ring that is integrally formed with a section of the piston housing.

In some embodiments, the piston housing includes at least two separate sections, and wherein the restrictor is integrally formed with one section of the at least two separate sections of the piston housing. In some of these embodiments, the integrally formed restrictor and piston section housing is constructed out of metal.

In some embodiments, at least two of the plurality of passageways are orientated laterally with respect to the piston housing. In some of these embodiments, the at least two of the plurality of passageways can vary in size or shape as the restrictor extends toward the closed end.

In some embodiments, at least two of the plurality of passageways are orientated longitudinally with respect to the piston housing. In some of these embodiments, the at least two of the plurality of passageways can vary in size or shape as the passageway extends toward the closed end.

In some embodiments, at least two of the plurality of passageways are orientated laterally with respect to the piston housing and at least two of the plurality of passageways are orientated longitudinally with respect to the piston housing.

In some embodiments, the discharge port is disposed in a lateral side wall of the piston housing.

In some embodiments, the discharge port is disposed in an end wall of the piston housing.

In accordance with another aspect of the present disclosure, a method is provided for making a restrictor for a snubbing device. The method comprises obtaining digital data associated with the snubbing device, the digital data representative of a restrictor having a plurality of passageways connected in fluid communication with a fluid discharge port; and using the digital data to fabricate the restrictor from a first material by a solid freeform fabrication process.

In some embodiments, the solid freeform fabrication process is selected from the group consisting of direct metal laser sintering (DMLS), selective laser sintering (SLS), electron beam melting (EBM), electron beam freeform fabrication (EBMM), and fused filament fabrication.

In some embodiments, the digital data is further representative of the restrictor integrally associated with an end cap section of a piston housing.

In some embodiments, the digital data is further representative of the discharge port being laterally disposed and the plurality of passageways being orientated laterally with respect to the restrictor.

In some embodiments, the digital data is further representative of the plurality of passageways including passageways being orientated longitudinally with respect to the restrictor.

In some embodiments, the digital data is further representative of the discharge port being longitudinally disposed and the plurality of passageways being orientated laterally with respect to the restrictor.

In accordance with yet another aspect of the present disclosure, a computer readable medium is provided having a computer executable component comprising CAD data to enable the fabrication of the snubbing devices of Claims 1-12 or parts thereof or implement the methods of Claims 13-18 utilizing a solid freeform fabrication process.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIGS. 1A and 1B illustrate one conventional snubbing arrangement in the prior art;

FIG. 2 is a perspective view of one representative embodiment of a snubbing device formed in accordance with one or more aspects of the present disclosure;

FIG. 3A is a longitudinal cross-sectional view of the snubbing device of FIG. 2 taken along lines 3-3 in FIG. 2 in the retracted position;

FIG. 3B is a longitudinal cross-sectional view of the snubbing device of FIG. 2 taken along lines 3-3 in FIG. 2 in the extended position;

FIG. 4 is an exploded view of the snubbing device of FIG. 2;

FIG. 5 is a perspective view of one representative embodiment of a manifold, shown as a snubbing ring, formed in accordance with one or more aspects of the present disclosure;

FIG. 6 is a cross-sectional view of the snubbing ring of FIG. 5 taken along lines 6-6 in FIG. 5;

FIG. 7 is a cross-section view of another representative embodiment of a snubbing device formed in accordance with one or more aspects of the present disclosure;

FIG. 8 is a cross-section view of yet another representative embodiment of a snubbing device formed in accordance with one or more aspects of the present disclosure;

FIG. 9 is a perspective view of one representative embodiment of a hydraulic cylinder formed in accordance with one or more aspects of the present disclosure, the hydraulic cylinder incorporating snubbing device(s) at each end thereof;

FIG. 10 is a cross-sectional view of the hydraulic cylinder of FIG. 9 taken along lines 10-10 in FIG. 9;

FIGS. 11A and 11B are partial cross-sectional views of the hydraulic cylinder of FIG. 10, wherein FIG. 11A illustrates the piston in a retracted position and FIG. 11B illustrates the piston in an extended position;

FIG. 12 is a flow chart depicting a representative example of a method for forming a component, such as the snubbing ring shown in FIGS. 5-6, one or more components of the snubbing devices of FIGS. 4, 7 and 8, or the hydraulic cylinder of FIGS. 9-10, in accordance with aspects of the present disclosure; and

FIG. 13 is a block diagram depicting one example of an environment for carrying out the representative method of FIG. 12.

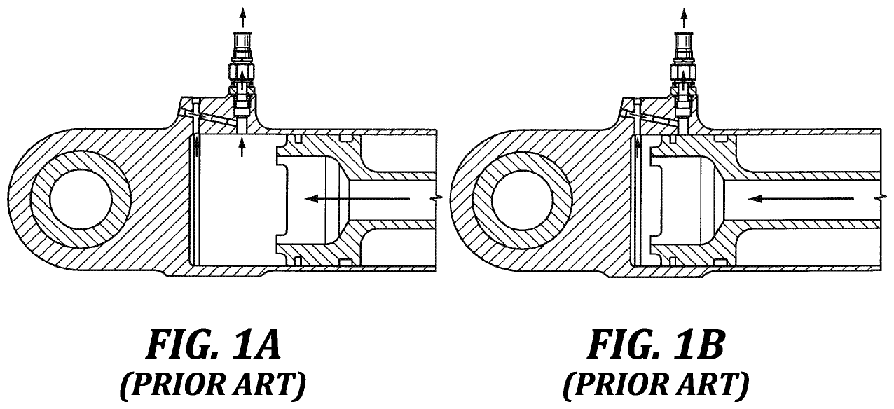

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

In the following description, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The following description provides several examples that relate to snubbing devices to arrest or resist motion. These snubbing devices are suitable for use with actuators, such as linear actuators, that desire load damping or piston speed change at the end of stroke movement of the actuator. Embodiments of the present disclosure also relate to linear actuators having a snubbing device for dampening loads, reducing piston velocity, etc., at the end of stroke movement of the actuator. In some embodiments, the snubbing device and/or other components of the actuator can benefit from additive manufacturing techniques or methodologies.

Some embodiments of the present disclosure may be suitably manufactured with any powder bed or direct deposition technology using the melting of rods/wire/powder, such as selective laser sintering (SLS), selective laser melting (SLM®), electron beam melting (EBM), or electron beam freeform fabrication (EBMM), sometimes referred to as electron beam additive manufacturing (EBAM®). Other solid freeform fabrication (SFF) technology, such as fused filament fabrication (FFF), sometimes referred to as fused deposition modeling (FDM®), etc., can be employed to manufacturer one or more components of the snubbing device, the actuator, or parts thereof. In some embodiments, the representative methods include optional post-machining, post-treatments, etc.

In some embodiments of the present disclosure, examples of piston-cylinder hydraulic snubbing devices are provided to arrest or resist motion. It will be appreciated that embodiments of the present disclosure may be utilized as a snubbing device alone, or embodiments of the present disclosure may be incorporated into, for example, a hydraulically or pneumatically actuated piston-cylinder assembly.

Generally, an actuator is a mechanical device for moving or controlling components, such as a mobile part, of a mechanism or system. Examples of a mobile part can include but are not limited to an aileron, a flap, an air brake, etc. Actuators receive energy and convert the energy into the mechanical motion of an actuator member. For example, the actuator member may be able to move between an extended position and a retracted position. The energy may be transmitted to the actuator member through the use of pressurized liquids (i.e. hydraulics) so that the actuator member moves in response to the pressure changes in the liquid. Alternatively, or additionally, the energy may be transmitted to the actuator member electrically or through other known means of transmitting energy. The energy transmission and the resulting movement of the mechanisms of the actuator (e.g. the movement of the actuator member) may be controlled remotely or locally and may be manually or automatically operated.

Actuators can be used to operate various components of larger systems. For example, an actuator can be used to operate (i.e. extend and/or retract) the landing gear or undercarriage of an aircraft. By way of further example, actuators can be used in a motor to transmit energy into movement of a device (e.g. a car, a plane, a drill, etc.).

A piston assembly is one example of an actuator. A piston assembly includes a piston that can move within the interior of a second member to transform energy imparted by a fluid entering or expanding inside the second member into rectilinear motion. The second member can be a cylinder for example. The fluid may, for example, be compressed air, explosive gases, or steam. In some systems that employ actuators to move a mobile part, it can be desirable to provide a device, referred to as a snubbing device, to damp and/or alter speed of a moving actuator member, as briefly described above.

Although the term “actuator” is used in some embodiments herein, it is recognized that other linearly movable parts could be substituted for the actuator without departing from scope of the claimed subject matter.

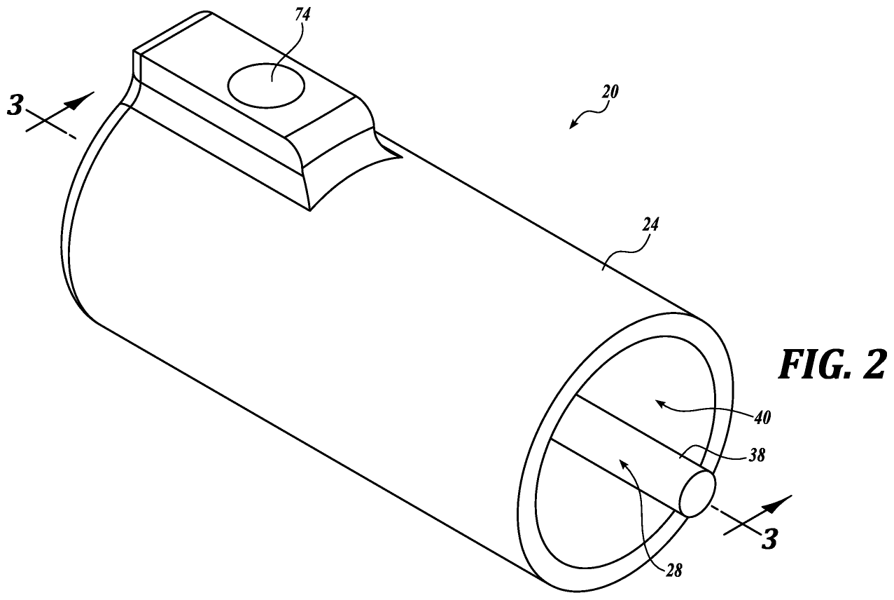

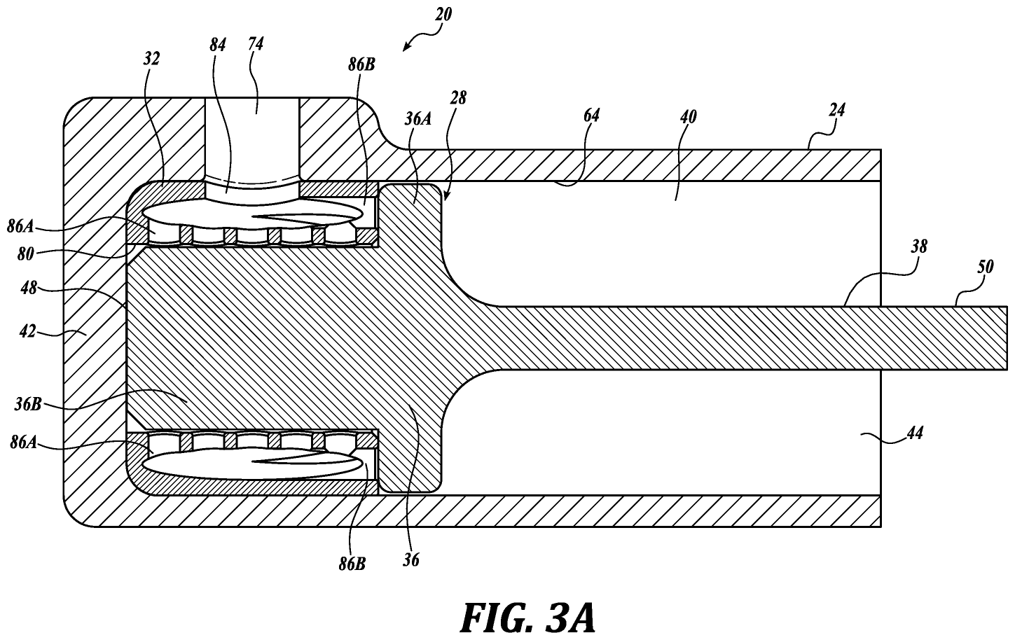

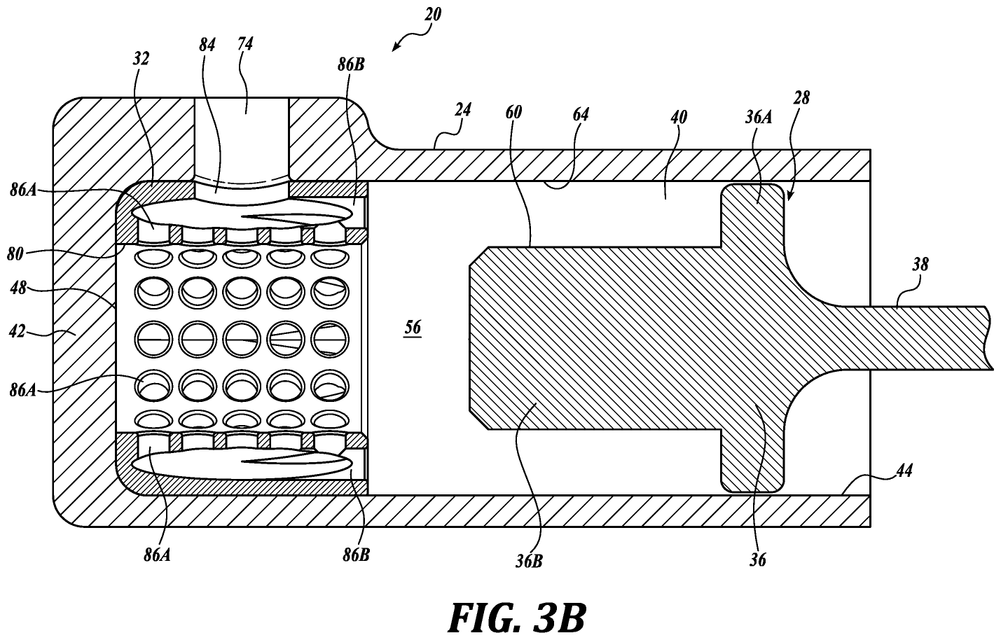

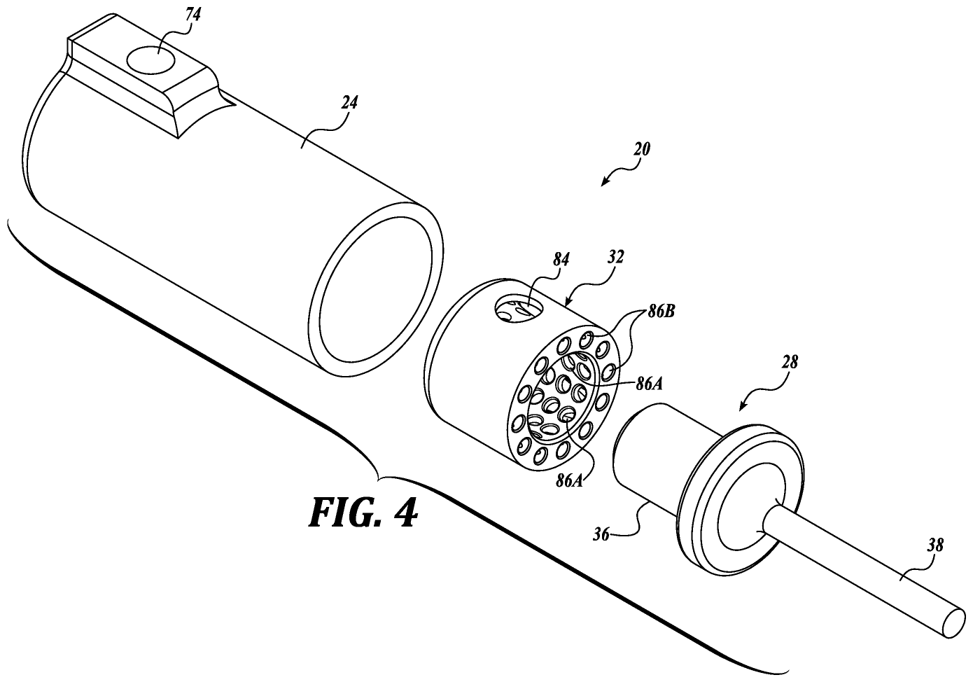

Turning now to FIGS. 2-4, there is shown one representative embodiment of a snubbing device 20 formed in accordance with one or more aspects of the present disclosure. As shown in FIGS. 2 and 3A-3B, the snubbing device 20 comprises a piston housing 24 that slideably houses a piston assembly 28. In some embodiments, the piston housing is cylindrical, although other cross-sectional shapes can be practiced with embodiments of the present disclosure.

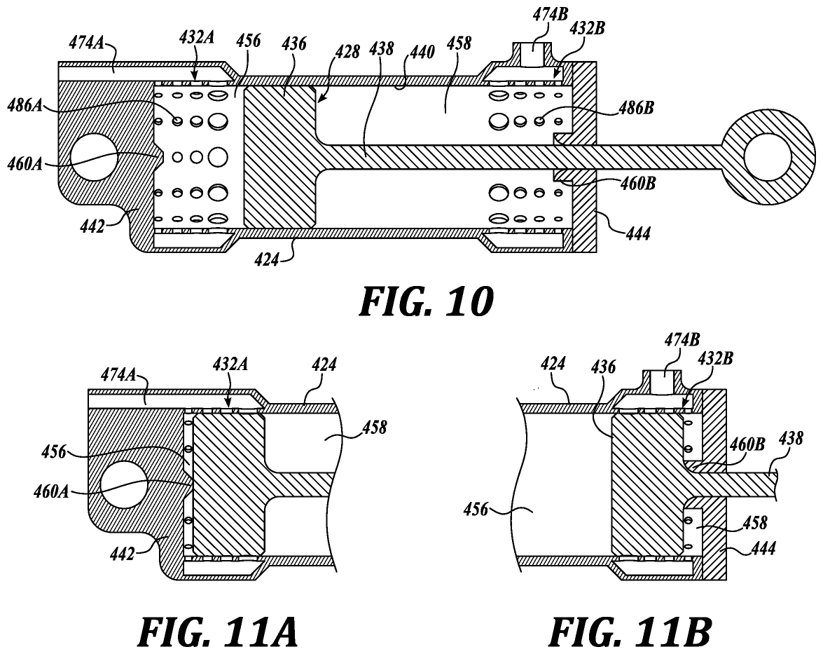

In use, the piston assembly 28 slides between extended (see FIG. 3B) and retracted or compressed (see FIG. 3A) positions, thereby defining an oscillating motion. As will be described in more detail below, the snubbing device 20 provides snubbing (e.g., the arrest or reduction of piston speed, damping, etc.) at the end of one (or both) of the extension and compression strokes of the piston assembly during oscillation via technologies and methodologies described herein. In the embodiment shown in FIGS. 2-4, snubbing is provided at the end of the compression stroke of the piston assembly. Alternatively or additionally, snubbing is provided at the end of the extension stroke of the piston assembly or both the compression and extension strokes of the piston assembly (see FIG. 10).

With reference to FIGS. 2-6, the components of the snubbing device 20 will now be described in more detail. The snubbing device 20 shown in FIGS. 2 and 3A-3B includes a piston assembly 28 that moves within a cooperatingly shaped interior 40 of the piston housing 24 between an extended position and a retracted position. In the embodiment shown in FIGS. 3A and 3B, the piston housing 24 has a closed end 42 and an open end 44 and the piston assembly 28 has a first end 48 and a second end 50. The first end 48 of the piston assembly 28 is proximal to the closed end 42 of the piston housing 24 when the piston assembly 28 is located within the piston housing 24, while the second end 50 is located externally of the piston housing 24 past the open end 44 thereof.

Referring to FIGS. 3A-3B, the piston assembly 28 includes a piston 36 mounted at the end of a piston shaft 38. In the embodiment shown, the piston 36 includes, for example, a stepped configuration comprising a first cylindrical section 36A having a first diameter positioned more proximal to the open end 44 of the piston housing 24 and a second, cylindrical section 36B having a smaller diameter positioned proximal to the closed end 42 of the piston housing 24. Of course, other piston configurations are possible and are within the scope of the claimed subject matter.

When the piston assembly 28 is located in the piston housing 24 a first fluid chamber 56 (see FIG. 3B) is defined in the interior 40 of the piston housing 24 by the exterior surface 60 of the first end 48 of the piston assembly 28 and the interior surface 64 of piston housing 24. The fluid chamber 56 varies in volume as the piston 36 moves between extended and retracted positions.

The piston housing 24 also includes a discharge port 74 positioned near the closed end 42. A manifold, formed as a snubbing ring 32 in the embodiment of FIGS. 2-4, is configured to fluidly interconnect the discharge port 74 to at least the fluid chamber 56 located in the interior 40 of the piston housing 24 for allowing fluid and/or gas to enter and/or exit the interior 40. In use, the manifold 32 provides routing of fluid entering or exiting the fluid chamber 56 (e.g. through a tube, pipe or other passage). When the pressure in the fluid chamber 56 is increased, a corresponding force is exerted on the first end 48 of the piston assembly 28 in order to, for example, damp and/or slow the speed of the piston assembly. In some embodiments, an increase in pressure of the first fluid chamber 56 caused by injection of fluid under pressure affects a positional change of the piston 36 to move toward the extension position, an example of which is shown in FIG. 3B.

In addition to acting like a manifold, the snubbing ring, in cooperation with the piston housing 24, functions as a flow control device, sometimes referred to herein as a restrictor, to provide a resistance against movement of the piston 36 at the end of its stroke. In some embodiments, the restrictor provides a variable restriction, such as progressively increasing restriction, against movement of the piston.

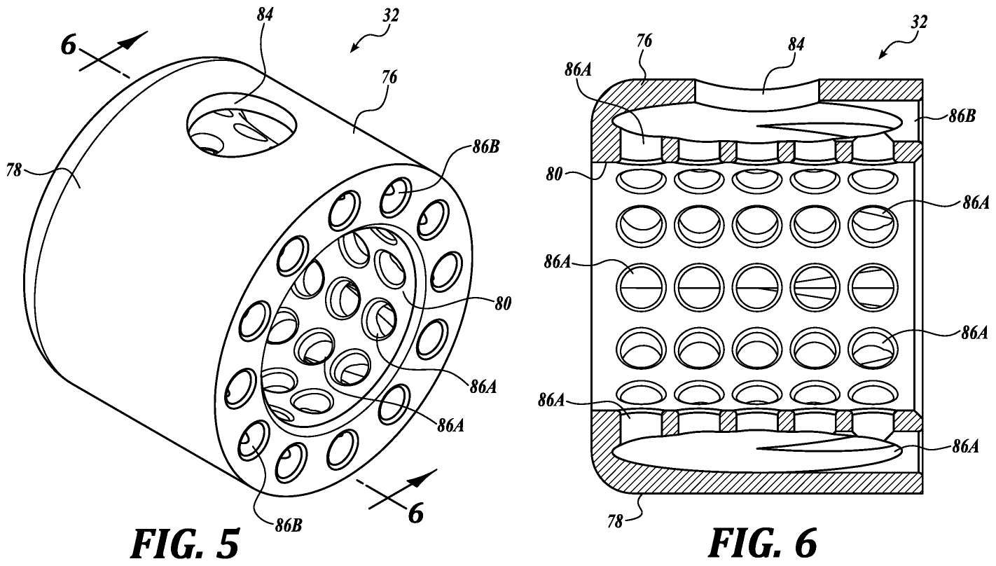

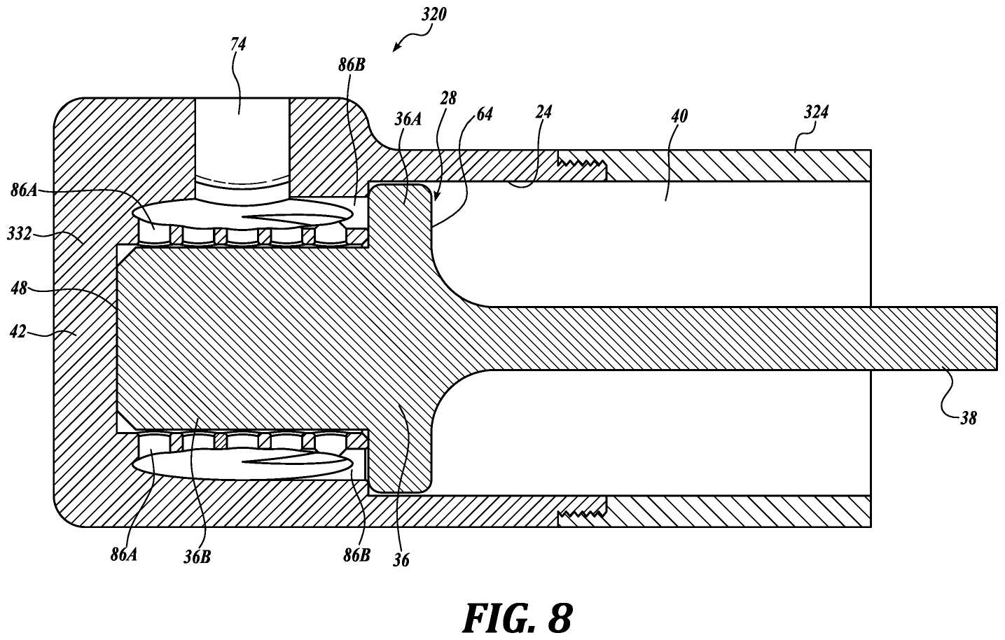

Turning now to FIG. 5, there is a perspective view of one representative embodiment of the snubbing ring 32 formed in accordance with one or more aspects of the present disclosure. In the embodiment shown, the snubbing ring 32 is suitably formed, for example, as an insert to be positioned near, next to or adjacent the closed end 42 of the piston housing 24. In some embodiments, the snubbing device 32 is integrally formed with an end cap, thereby forming a snubbing end section 232, which can be selectively or permanently attached to a section of the piston housing, as shown in FIG. 8. In yet other embodiments, the snubbing device can be integrally formed within an actuator (see FIGS. 10 and 11A-11B, which illustrates a snubbing device at both the retracted and extension strokes of the piston assembly).

Referring now to FIGS. 5 and 6, the snubbing ring 32 includes a device body 76 having an outer surface 78 that is configured to cooperate with the interior surface 64 of the piston housing 24. In some embodiments, the device body 76 is received in the piston housing 24 in a slideably seating or sealing manner. Of course, one or more seals can be alternatively or additionally employed between the outer surface of the device body and the interior surface of the piston housing. Keying structure can be provided in some embodiments to maintain alignment of the snubbing ring 32 with the discharge port 74 of the piston housing 24. Alternatively or additionally, the snubbing ring 32 can be configured to be threadably connected to cooperating structure of the piston housing 24.

The device body 76 is formed with a central through bore 80 (see FIG. 3B), and a discharge port 84 that is fluidly connected to a number of fluid passageways 86 that open to the interior 40 of the piston housing 24 and communicate with the first fluid chamber 56 (see FIG. 3B). In some embodiments, a first subset of the fluid passageways, designated 86A, are oriented generally transverse to or laterally into the through bore 80. In this or other embodiments, a second subset of the fluid passageways, designated 86B, is provided, which open to the side of the snubbing ring, generally parallel with the longitudinal axis of the piston assembly. The second subset 86B of the fluid passageways 86 faces the piston 36 when the snubbing device is assembled. Each fluid passageway 86 is fluidly connected to the fluid opening 84, which opens out of the exterior surface 78 of the body 76. In the embodiment shown, the fluid opening 84 opens laterally outwardly of the body 76. Of course, other fluid orientations and/or configurations of the passageways and fluid openings are contemplated and can be practiced with one or more embodiments of the present disclosure. When the snubbing device 20 is assembled, the snubbing ring 32 is positioned such that the fluid opening 84 is fluidly connected to the discharge port 74.

It will be appreciated that the size and/or shape of one or more of the fluid passageways can vary as they extend toward the closed end 42 of the piston housing 24. In other embodiments, the size and/or shape of one or more of the fluid passageways remains constant as it extends toward the closed end 42 of the cylindrical piston housing 24. In some embodiments, each passageway can vary in size or shape as the restrictor extends toward the closed end. In other embodiments, each passageway can remain constant in size or shape as the restrictor extends toward the closed end.

The shapes, sizes, number and/or locations of the fluid passageways each or collectively in any combination can be chosen to provide any desired damping characteristics, reduction in piston velocity, etc., for a given application. In some embodiments, the snubbing ring can be selected from a group of snubbing rings with different fluid passageway configurations (restriction profiles) for use with the snubbing device 20. In an embodiment, the snubbing device 20 can be sold as a kit with a group of snubbing rings with different fluid passageway configurations (restriction profiles).

In operation, as the piston assembly 28 moves from the extended position of FIG. 3B to the compressed or retracted position of FIG. 3A, from a motive force exerted on, for example, piston rod 38, the piston 36 pushes hydraulic fluid from the first fluid chamber 56 into the passageways 86 which route the fluid to the discharge port 74 and out of the piston housing 24. As the piston assembly 28 continues moving towards the compressed or retracted position of FIG. 3A, the piston section 36B progressively shuts off communication between the passageways and the chamber 56. The hydraulic fluid is then only able to pass into the remaining, unblocked passageways. Thus, the snubbing ring 32 acts as a restrictor or fluid control device as the piston continues to move toward the closed end 42. In other words, the snubbing ring 32 controls the rate at which the fluid flows between the chamber 56 and the discharge port 74. In the embodiment shown, the rate of fluid flow progressively decreases, and pressure in the chamber 56 increases, as the piston blocks successively the passageways 86. Therefore, as the piston 36 moves from the extended position to the compressed or retracted position, fluid flow from the chamber 56 (and hence the hydraulic pressure of the fluid in the chamber 56) is controlled using the snubbing ring 32, resulting in a snubbing operation.

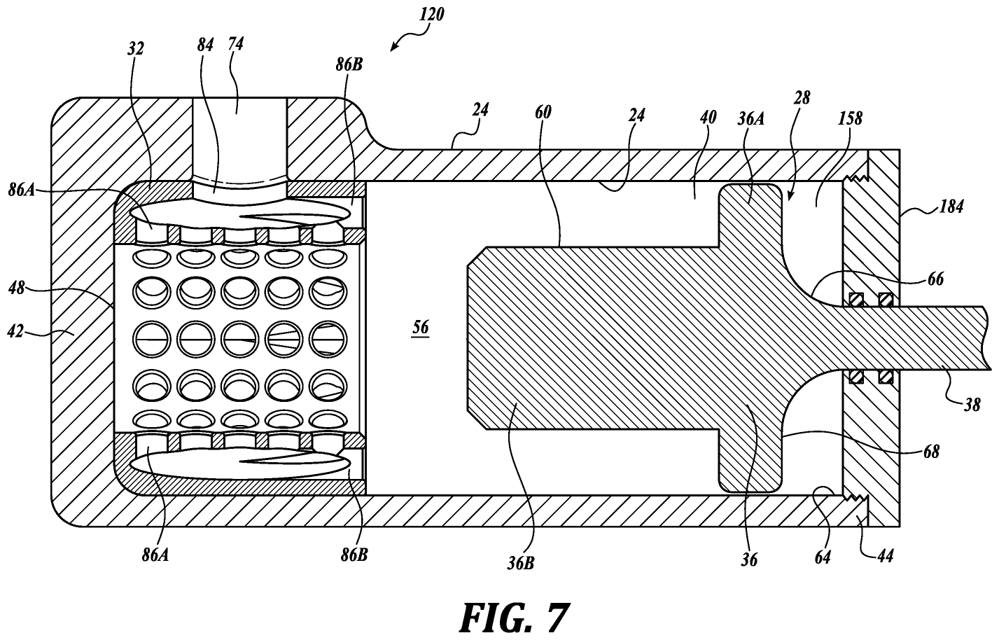

FIG. 7 is another embodiment of a snubbing device 120 formed in accordance with one or more aspects of the present disclosure. The snubbing device 120 is substantially identical in materials and operation as snubbing device 20 except for the differences that will now be described in detail. In the embodiment shown in FIG. 7, the open end 44 of the piston housing 24 is capped or otherwise plugged via end cap 184. The end cap 184 can be screwed or otherwise attached onto the open end of the piston housing 24. As a result of end cap 184 closing the open end 44 of the piston housing 24, a second fluid chamber 158 is defined in the interior 40 of the piston housing 24 between the outer surface 66 of the piston rod 38, the back surface 68 of piston section 36A and the interior surface 64 of the piston housing 24.

In embodiments that includes second fluid chamber 158, when the pressure in the second fluid chamber 158 is increased by injection of pressurized fluid, the piston assembly 28 is forced toward the closed end 42 of the piston housing 24, thus moving the piston assembly 28 into the retracted position. Pressurized fluid can be introduced to the second fluid chamber 158 via a suitable port (not shown) through the piston housing 24 or the end cap 184. Additionally or alternatively, the end of the snubbing device 120 with the end cap 184 can employ a snubbing arrangement (not shown) to damp or arrest movement of the piston assembly 28 as the piston assembly transitions from the retracted position to the extended position.

FIG. 8 is still another embodiment of a snubbing device 320 formed in accordance with one or more aspects of the present disclosure. The snubbing device 320 is substantially identical in materials and operation as snubbing device 20 except for the differences that will now be described in detail. In the embodiment shown in FIG. 8, the manifold 32 is integrally formed with the closed end 42 of the piston housing to form a snubbing end section 332. The snubbing end section 332 can be threadably connected to a cylindrical housing section 324 via any suitable arrangement. In some embodiments, the snubbing end section 332 is constructed out of metal, such as aluminum, etc.

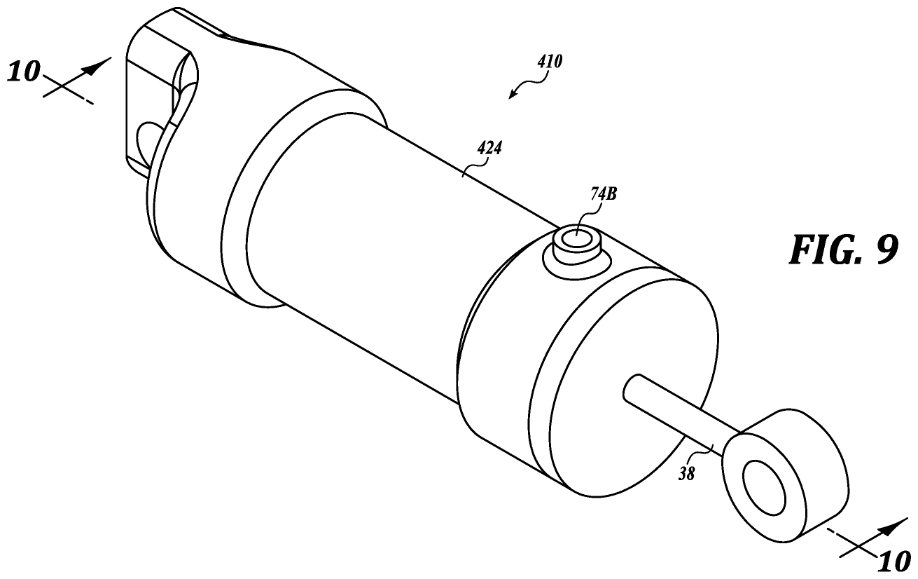

FIG. 9 is representative embodiment of a hydraulic actuator 410 formed in accordance with one or more aspects of the present disclosure. The hydraulic actuator 410 incorporates one or more snubbing devices 420. The snubbing devices 420 are substantially identical in materials and operation as snubbing devices 320 except for the differences that will now be described in detail.

As shown in longitudinal cross-section of FIG. 10, the hydraulic actuator 410 comprises a piston housing 424 that slideably houses a piston assembly 428. In use, the piston assembly 428 slides between retracted (see FIG. 11A) and extended (see FIG. 11B) positions, thereby defining an oscillating motion. The hydraulic actuator 410 provides snubbing (e.g., the arrest or reduction of piston speed, damping, etc.) at the end of the extension and retraction strokes of the piston assembly 428 during oscillation.

With reference to FIGS. 9, 10 and 11A-11B, the components of the hydraulic actuator 410 will now be described in more detail. As shown in FIGS. 9, 10, and 11A-11B, the hydraulic actuator 410 includes a piston assembly 428 that moves within a cooperatingly shaped interior 440 of the piston housing 24 between an extended position and a retracted position. In the embodiment shown, the piston housing 424 is closed at both ends 442 and 444. The piston assembly 428 includes a piston 436 mounted at the end of a piston shaft 438. When the piston assembly 428 is located in the piston housing 424, first and second fluid chambers 456 and 458 (see FIG. 10) is defined in the interior 440 of the piston housing 424. The fluid chambers 456 and 458 vary in volume as the piston 436 moves between extended and retracted positions.

The piston housing 424 also includes a first discharge port 474A positioned near the closed end 442 and a second discharge port 474B positioned near the closed end 444. In the embodiment shown, the first discharge port 474A is formed in the end wall of the piston housing 424 and the second discharge port 474B is formed in a lateral side wall of the piston housing 424, although other configurations can be practiced with embodiments of the present disclosure. Manifolds 432A and 432B are formed (e.g., integrally in FIG. 10) in the piston housing 424 and are configured to fluidly interconnect the first and second discharge ports 474A and 474B to at least the first and second fluid chambers 456 and 458, respectively, for allowing fluid and/or gas to enter and/or exit the interior 440.

In use, the manifolds 432A and 432B provide routing of fluid entering or exiting the fluid chambers 456 and 458 (e.g. through a tube, pipe or other passage). For example, when the pressure in the first fluid chamber 456 is increased, a corresponding force is exerted on a first end of the piston assembly 428 in order to, for example, damp and/or slow the speed of the piston assembly as it approaches the retracted position. Likewise, when the pressure in the second fluid chamber 458 is increased, a corresponding force is exerted on a second end of the piston assembly 428 in order to, for example, damp and/or slow the speed of the piston assembly as it approaches the extended position. Due to the presence of bosses 460A and 460B formed at ends 442 and 444, an increase in pressure of either the first fluid chamber 456 or the second fluid chamber 458 caused by injection of fluid under pressure affects a positional change of the piston 436 to move toward either the extended position, an example of which is shown in FIG. 11B, or the retracted position, an example of which is shown in FIG. 11A.

The manifolds 432A and 432B are also configured to function as flow control devices, sometimes referred to herein as restrictors, to provide resistance against movement of the piston 436 at the ends of its stroke. In some embodiments, the restrictors provide a variable restriction, such as progressively increasing restriction, against movement of the piston. Toward that end, the manifolds 432A and 432B include a number of fluid passageways or orifices 486A and 486B. It will be appreciated that the size and/or shape of one or more of the fluid passageways or orifices 486A and 486B can remain constant or can vary as they extend toward the ends 442 and 444 of the piston housing. In some embodiments, each passageway or orifice can vary in size or shape or can remain constant as restrictor extends laterally outwardly toward the piston housing. Of course, the shapes, sizes, number and/or locations of the fluid passageways each or collectively in any combination can be chosen to provide any desired damping characteristics, reduction in piston velocity, etc., for a given application.

According to aspects of the present disclosure, one or more components or component parts described herein may be fabricated by additive manufacturing (AM) techniques. Conventionally, components of a snubbing device have been heretofore fabricated by traditional metal forging techniques, casting techniques, or metal forming techniques. In one aspect of the present disclosure, an alternative fabrication technique or methodology is provided wherein the snubbing device 20, 120, 320, or parts thereof, such as the snubbing ring 32, snubbing end section 132, etc., or the hydraulic actuator 410 or parts thereof, is fabricated layer by layer via the process of, for example, direct metal laser sintering (DMLS), selective laser sintering (SLS), selective laser melting (SLM®), electron Beam Melting (EBM), electron beam freeform fabrication (EBMM), sometimes referred to as electron beam additive manufacturing (EBAM®), fused filament fabrication (FFF), sometimes referred to as fused deposition modeling (FDM®), or a similar form of additive manufacturing, depending, for example, on material selection, desired properties of the finished part, the part's intended application, etc. Embodiments of these components or component parts can be fabricated as described below. Other embodiments of the components or component parts can be fabricated with any conventional process, such as extrusion, forging, milling, casting, metal forming, etc.

In some embodiments of the present disclosure, the snubbing devices 20, 120, 320, or parts thereof, such as the snubbing ring 32, snubbing end section 132, etc., or the hydraulic actuator 410 or parts thereof, is fabricated out of metal in an additive manufacturing technique. Additive manufacturing is a type of three-dimensional (3D) printing where material is solidified in a pattern controlled by computer-aided design (CAD) instructions, and the part being produced is built on a layer-by-layer basis. Unlike a conventional machining process, where material is removed from stock to produce a part, additive manufacturing builds the part by adding layers, where each layer is solidified by a computer-controlled source, such as a laser or an electron-beam, before the tray, bed, etc., moves incrementally to allow a new layer to be solidified adjacent the previous layer, or by adding solid stock material directly. Additive manufacturing is capable of producing parts from a wide variety of materials, including metals, polymers, and minerals.

One type of additive manufacturing, powder bed fusion (e.g., selective laser sintering (SLS), selective laser melting (SLM®), etc.), can be used to fabricate the snubbing devices 20, 120, 320, or parts thereof, such as the snubbing ring 32, snubbing end section 132, etc., or the hydraulic actuator 410 or parts thereof. The powder bed fusion technique uses a high power-density laser or an electron-beam to melt and infuse a metallic powder into a solid. A wide variety of alloys are compatible with the powder bed fusion technique. To start the process, a 3D CAD model is broken into layers, typically on the order of 10 to 100 μm thick, and each layer is converted to a two-dimensional (2D) image for processing. During the additive manufacturing of the powder bed fusion technique, a thin layer of metal powder is applied to an operating plate or bed, and the laser traces the 2D image of a layer, melting and fusing the powdered metal together into the shape of the layer dictated by the CAD data. Then, the plate lowers by the thickness of a layer and the recently printed layer is covered by another thin layer of the metal powder and the laser traces the next image of a layer, melting and fusing the powdered metal together into the shape of the new layer and to the previously printed layer.

In other embodiments, the snubbing devices 20, 120, 220, or parts thereof, such as the snubbing ring 32, snubbing end section 132, etc., or the hydraulic actuator 410 or parts thereof, can be fabricated out of metal wire using electron-beam melting (EBM) or electron beam additive manufacturing (EBAM®). Differing from the SLS process, direct deposition, such as electron-Beam melting or electron beam additive manufacturing (EBAM) uses a wire feed used to produce complex metal parts using a heat source, (e.g., electron-beam) to generate heat and melt a solid metal stock (e.g., wire or rod) into a part. The direct deposition process creates parts in an additive manner, directly depositing a solid metal stock. The direct deposition process is able to produce metal parts with strength approximately equivalent to forged metal parts.

In some other embodiments of the present disclosure, the snubbing device 20, 120, 220, or parts thereof, such as the snubbing ring 32, snubbing end section 132, etc., or the hydraulic actuator 410 or parts thereof, can be fabricated out of thermoplastic, employing fused filament fabrication (FFF) techniques, such as fused deposition modeling (FDM®). Generally described, fused deposition modeling techniques employ a fused deposition modeling system to build a 3D part or model from a digital representation of the 3D part in a layer-by-layer manner by extruding a flowable part material. The part material is extruded through an extrusion tip carried by an extrusion head, and is deposited as a sequence of roads on a substrate in an x-y plane. The extruded part material fuses to previously deposited modeling material, and solidifies upon a drop in temperature. The position of the extrusion head relative to the substrate is then incremented along a z-axis (perpendicular to the x-y plane), and the process is then repeated to form a 3D part resembling the digital representation.

Movement of the extrusion head with respect to the substrate is performed under computer control, in accordance with build data that represents the 3D part. The build data is obtained by initially slicing the digital representation of the 3D part into multiple horizontally sliced layers. Then, for each sliced layer, the host computer generates a build path for depositing roads of modeling material to form the 3D part.

Of course, in some embodiments, a combination of two or more additive manufacturing techniques briefly described above can be employed to fabricate the snubbing device 20, 120, 220, or parts thereof, such as the snubbing ring 32, snubbing end section 132, etc., or the hydraulic actuator 410 or parts thereof. After fabrication, other post-machining or post-processing steps can be carried out.

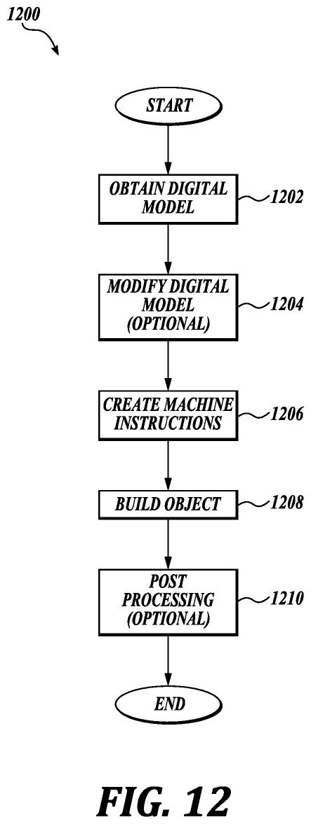

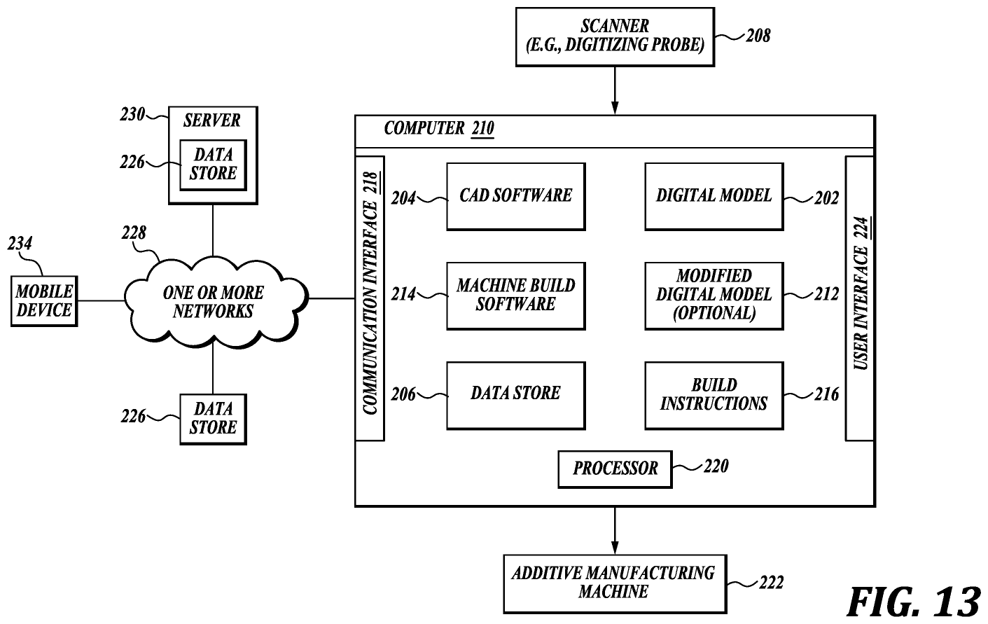

FIG. 12 is a block diagram illustrating a representative fabrication process of a component part of the snubbing device, such as the snubbing ring 32, snubbing end section 132, etc., or the hydraulic actuator 410 or parts thereof. FIG. 13 is a block diagram depicting one environment, including one or more components of a system, used to carry out the one or more processes of the method set forth in FIG. 12. As can be seen in FIG. 12, the first step in the process is obtaining, at block 1202, a digital model 202 (see FIG. 13), such as a Computer Aided Design (CAD) solid model or CAD surface model, of an object to be fabricated, such as the snubbing ring 32, snubbing end section 132, the hydraulic actuator 410, etc. In some embodiments, the digital model includes graphical 2D or 3D data representing the object to be fabricated.

The digital model 202 at block 1202 may be obtained in a number of ways. For example, the digital model 202 may be obtained by generating a solid model of, for example, the manifold body 76, and/or surface model of the inner surfaces of the passageways within CAD software 204 (see FIG. 13). In other embodiments, the digital model 202 may be obtained from a data store, such as data store 206 of the computer 210, which stores one or more CAD models of component parts, such as an actuator or snubbing device, for various applications, such as landing gear for a BOEING® 737, BOEING® 777, BOEING® 787, AIRBUS® 320, AIRBUS® 330, BOMBARDIER® Global 7500, EMBRAER® E195, just to name a few. It will be appreciated that the digital model 202 may be obtained from other data stores, such as a data store 226 associated with either a local or remote server 230 or cloud based storage solution. Such communication with these data stores 226 is facilitated by communications interface 218 through one or more networks 228.

In other embodiments, the digital model 202 may be obtained by scanning a previously fabricated component part, a prototype of the component part made from clay modeling, etc., and inputting the scanned data into a suitable CAD program, such as CAD software 204. For example, a component or component part may be scanned (e.g., measured) using a digitizing probe 208 that traverses the surfaces of the component part to generate suitable 2 and 3 dimensional data indicative of the geometry thereof.

In yet other embodiments, the digital model 202 can be created in a CAD system with the use of computer 210 and CAD software 204. The design can be general to very detailed, but generally includes design details such as external shape and size of the part, internal passageway sizes, shapes and location, and the like. In some embodiments, the digital model includes graphical data representative of the snubbing ring 32, snubbing end section 132, the hydraulic actuator 410, etc.

Once the digital model 202 of the component part is obtained, the method 1200 continues to block 1204, where the digital model 202 can be viewed and optionally manipulated by the computer 210 within CAD software 204. For example, at block 204, the CAD technician or the like can interactively modify the digital model 202 via the CAD software 204 in order to alter the geometry of one or more portions of the component part, aiming for improved characteristics, modifications for a custom or new installation, etc. In some embodiments, the modified digital model 204 includes graphical data representative of the snubbing ring 32, snubbing end section 132, the hydraulic actuator 410, etc.

Examples of suitable CAD software that be employed for carrying out aspects of some embodiments of the present disclosure include but are not limited to Solid Works, Pro-E, CATIA, etc. Once obtained and/or modified, the digital model 202 or modified digital model 212 (optional) can be saved, for example, to system memory, such as the data store 206, and/or associated memory, such as data store 226 from a local or remote server 230 or a cloud based storage solution.

Once the CAD design is created, the object, such as the snubbing ring 32, snubbing end section 132, etc., can then be fabricated with the use of any suitable additive manufacturing process, such as fused filament fabrication (e.g., fused deposition modeling (FDM®)), stereolithography (SLA), selective laser sintering (SLS), electron beam melting (e.g., electron beam additive manufacturing (EBAM®)), among others, with an additive manufacturing machine 222. In one embodiment, the object, such as the snubbing ring 32, snubbing end section 132, the hydraulic actuator 410, etc., is fabricated by an FDM® apparatus. In another embodiment, the object, such as the snubbing ring 32, snubbing end section 132, hydraulic actuator 410, etc., is fabricated by an EBM apparatus or an EBAM® apparatus.

The additive manufacturing machine 222 is utilized to fabricate the component part in three dimensions on a bed, tray, etc., such as a fixtureless platform, from a CAD data file, such as the digital model 202 or modified digital model 204. In order for the additive manufacturing machine 222 to fabricate the component part in some embodiments, the CAD data file, such as the digital model 202 or modified digital model 204, may need to be translated into suitable machine instructions. Accordingly, at block 1206 of the method 1200, the digital model 202 or modified digital model 212 is processed for compatibility with the manufacturing system, including the additive manufacturing machine 222. In an embodiment of the present disclosure, a surface file (also known as a .stl file) is created from the either the digital model 202 or the modified digital model 212, depending on which is being used to fabricate the component part. The surface file conversion allows the manufacturing system to read CAD data from any one of a variety of CAD systems, such as CAD software 204 running on computer 210. In some embodiments, processing of the CAD data file (e.g., digital model 202, modified digital model, etc.) can be carried out by the computer 210, the additive manufacturing apparatus 222 or a combination of the computer 210 and the additive manufacturing apparatus 222.

It will be appreciated that the CAD data files or surface files may be stored on a computer-readable medium either associated with the CAD system, the manufacturing system or a networked or cloud based storage solution. For example, computer-readable media can be any available media that can be accessed by the computer 210 or the computer 210 and/or the additive manufacturing apparatus 222. By way of example, and not limitation, computer-readable media may comprise computer storage media and communication media. Computer storage media includes volatile and nonvolatile, removable and non-removable media implemented in any method or technology for storage of information such as computer readable instructions, data structures, program modules or other data.

In some embodiments, this surface file is then converted into cross-sectional slices or slice files, where each slice can be uniquely defined about its build strategy by varying the tool path, laser, electron beam, tray, etc., of the machine 222. Various 3-D printing techniques are additive manufacturing processes that use a layered manufacturing approach to fabricate three-dimensional objects on a fixtureless platform from its CAD data file.

Once suitable machine instructions are created (if needed), such as the surface and/or slice files, at block 906, these machine instructions are then used by the additive manufacturing machine 222 to build the object or component part at block 908.

In one embodiment, a FDM apparatus is used to carry out the machine instructions. In this regard, a filament of the desired material passes through a heated liquefier. In some embodiments, the desired material is selected from a group consisting of thermoplastics. In some embodiments, the thermoplastics includes a class of thermoplastics comprising polyetherketoneketone (PEKK), such as Antero 800NA from Stratasys Direct Manufacturing. Other examples of materials that may be used in these embodiments include but are not limited to nylon, ABS, polyetherimide (e.g., Ultem®), thermoplastic polyurethane (TPU). Of course, other materials may be used.

The liquefier melts the material and extrudes a continuous bead, or road, of material through an extrusion tip carried by an extrusion head and deposits the material on a fixtureless platform. The extrusion head is computer controlled along the X and Y directions, based on the build strategy of the part to be manufactured and represented in the CAD data file. When deposition of the first layer is completed, the fixtureless platform indexes down, and the second layer is built on top of the first layer. This process continues under computer control on a layer by layer basis until the part manufacturing is completed.

In another embodiment, an EBAM® apparatus is used to carry out the machine instructions. With EBAM®, an electron beam is used to melt wire onto a surface to build up a part. With this process, an electron-beam gun provides the energy source used for melting metallic feedstock, which is typically wire. In some embodiments, the desired wire material is selected from a group consisting of titanium, nickel chromium, austenitic nickel chromium (e.g., Inconel®, etc.), stainless steel, just to name a few. Using EBAM®, feedstock material is fed into a molten pool created by the electron beam. Through the use of computer controls, the molten pool is moved about on a substrate plate, adding material where it is needed to produce the object based on the build strategy of the part to be manufactured and represented in the CAD data file. This process is repeated in a layer-by-layer fashion, until the desired 3D object is produced.

After the object, such as the snubbing ring 32, snubbing end section 132, hydraulic actuator 410, etc., is built at block 1208, one or more post processing steps can be optionally carried out at block 1210. For example, the passageways 86 or other surfaces can be deburred or otherwise smoothed, as needed.

As described above, one or more aspects of the method are carried out in a computer system. In this regard, a program element is provided, which is configured and arranged when executed on a computer for fabricating the component part, including but not limited to the snubbing ring 32, snubbing end section 132, hydraulic actuator 410, etc. The program element may specifically be configured to perform the steps of: obtaining digital data associated with the snubbing device, the digital data representative of a restrictor having a plurality of passageways connected in fluid communication with a fluid discharge port; and using the digital data to fabricate the restrictor from a first material by a solid freeform fabrication process.

The program element may be installed in a computer readable storage medium. The computer readable storage medium may be any one of the computing devices, control units, etc., described elsewhere herein or another and separate computing device, control unit, etc., as may be desirable. The computer readable storage medium and the program element, which may comprise computer-readable program code portions embodied therein, may further be contained within a non-transitory computer program product.

As mentioned, various embodiments of the present disclosure may be implemented in various ways, including as non-transitory computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory VRAM, cache memory (including various levels), flash memory, register memory, and/or the like. It will be appreciated that where embodiments are described to use a computer-readable storage medium, other types of computer-readable storage media may be substituted for or used in addition to the computer-readable storage media described above. In some embodiments, the data store 206 and/or data store(s) 226 can comprise one or more of the computer readable storage media.

As should be appreciated, various embodiments of the present disclosure may also be implemented as methods, apparatus, systems, computing devices, computing entities, and/or the like, as have been described elsewhere herein. As such, embodiments of the present disclosure may take the form of an apparatus, system, computing device, computing entity, and/or the like executing instructions stored on a computer-readable storage medium to perform certain steps or operations. However, embodiments of the present disclosure may also take the form of an entirely hardware embodiment performing certain steps or operations.

Various embodiments are described above with reference to block diagrams and flowchart illustrations of apparatuses, methods, systems, and computer program products. It should be understood that each block of any of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, could be implemented by special purpose hardware-based computer systems that perform the specified functions or operations, or combinations of special purpose hardware and computer instructions.

In some embodiments, one such special purpose computer includes computer 210. Computer 210 includes a processor 220 configured to executed program code, such as the CAD software 204 and/or machine build software 214. While a single processor can be employed, as one of ordinary skill in the art will recognize, the computer 210 and/or additive manufacturing machine 222 may comprise multiple processors operating in conjunction with one another to perform the functionality described herein. In addition to the memory (e.g., computer readable storage media), which is implemented in some embodiments as data store 206, the processor 220 can also be connected to at least one interface or other means for displaying, transmitting and/or receiving data, content or the like. In this regard, the interface(s) can include at least one communication interface 218 or other means for transmitting and/or receiving data, content or the like, as well as at least one user interface 224 that can include a display and/or a user input interface. The user input interface, in turn, can comprise any of a number of devices allowing the entity to receive data from a user, such as a keypad, a touch display, a joystick or other input device.

The communication interface 218 in some embodiments is configured to transmit and/or receive data, content or the like from other devices via one or more networks 228. According to various embodiments, the one or more networks 228 may be capable of supporting communication in accordance with any one or more of a number of cellular protocols, including second-generation (2G), 2.5G, third-generation (3G), fourth-generation (4G) mobile communication protocols, or the like, as well as other techniques such as, for example, radio frequency (RF), Bluetooth™, infrared (IrDA), or any of a number of different wired or wireless networking techniques, including a wired or wireless Personal Area Network (“PAN”), Local Area Network (“LAN”), Metropolitan Area Network (“MAN”), Wide Area Network (“WAN”), or the like. Although the computer 210, the server 230, and the mobile device 234 are illustrated in FIG. 9 as communicating with one another over the same network, these devices may likewise communicate over multiple, separate networks.

According to various embodiments, many individual steps of a process may or may not be carried out utilizing the computer systems and/or servers described herein, and the degree of computer implementation may vary, as may be desirable and/or beneficial for one or more particular applications.

Some embodiments of the present disclosure may reference components or component parts suitable for use in aircraft. However, it will be appreciated that aspects of the present disclosure transcend any particular vehicle type or industry, and any reference to aircraft or the like is only representative, and therefore, should not be construed as limiting the scope of the claimed subject matter.

The present application may include references to directions, such as “forward,” “rearward,” “front,” “rear,” “upward,” “downward,” “top,” “bottom,” “right hand,” “left hand,” “lateral,” “medial,” “distal,” “proximal,” “in,” “out,” “extended,” etc. These references, and other similar references in the present application, are only to assist in helping describe and to understand the particular embodiment and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A snubbing device, comprising:
a piston housing having an interior, at least one closed end, and a discharge port disposed close to the closed end;
a piston disposed in the interior of the piston housing and forming a fluid chamber between one end of the piston and the closed end of the piston housing; and
a 3-D printed restrictor positioned against the closed end of the piston housing, the restrictor having a plurality of passageways connected in fluid communication with the discharge port.

2. The snubbing device of claim 1, wherein the 3-D printed restrictor includes a snubbing ring that is inserted into the interior of the piston housing and positioned adjacent the closed end.

3. The snubbing device of claim 1, wherein the 3-D printed restrictor includes a snubbing ring that is integrally formed with a section of the piston housing.

4. The snubbing device of claim 1, wherein the piston housing includes at least two separate sections, and wherein the restrictor is integrally formed with one section of the at least two separate sections of the piston housing.

5. The snubbing device of claim 3, wherein the integrally formed restrictor and piston section housing is constructed out of metal.

6. The snubbing device of claim 3, wherein at least two of the plurality of passageways are orientated laterally with respect to the piston housing.

7. The snubbing device of claim 6, wherein the at least two of the plurality of passageways can vary in size or shape as the restrictor extends toward the closed end.

8. The snubbing device of claim 3, wherein at least two of the plurality of passageways are orientated longitudinally with respect to the piston housing.

9. The snubbing device of claim 8, wherein the at least two of the plurality of passageways can vary in size or shape as the passageway extends toward the closed end.

10. The snubbing device of claim 3, wherein at least two of the plurality of passageways are orientated laterally with respect to the piston housing and at least two of the plurality of passageways are orientated longitudinally with respect to the piston housing.

11. The snubbing device of claim 1, wherein the discharge port is disposed in a lateral side wall of the piston housing.

12. The snubbing device of claim 1, wherein the discharge port is disposed in an end wall of the piston housing.

13. A method of making a restrictor for a snubbing device, comprising:
obtaining digital data associated with the snubbing device, the digital data representative of a restrictor having a plurality of passageways connected in fluid communication with a fluid discharge port;
using the digital data to fabricate the restrictor from a first material by a solid freeform fabrication process.

14. The method of claim 13, wherein the solid freeform fabrication process is selected from the group consisting of direct metal laser sintering (DMLS), selective laser sintering (SLS), electron beam melting (EBM), electron beam freeform fabrication (EBMM), and fused filament fabrication.

15. The method of claim 13, wherein the digital data is further representative of the restrictor integrally associated with an end cap section of a piston housing.

16. The method of claim 13, wherein the digital data is further representative of the discharge port being laterally disposed and the plurality of passageways being orientated laterally with respect to the restrictor.

17. The method of claim 16, wherein the digital data is further representative of the plurality of passageways including passageways being orientated longitudinally with respect to the restrictor.

18. The method of claim 13, wherein the digital data is further representative of the discharge port being longitudinally disposed and the plurality of passageways being orientated laterally with respect to the restrictor.

19. A computer readable medium having a computer executable component comprising CAD data to enable the fabrication of a snubbing device or parts of the snubbing device utilizing a solid freeform fabrication process.
